(19) United States
(12) Patent Application Publication
(10) Pub. No.: US 2006/0063101 A1
(43) Pub. Date: Mar. 23, 2006

(54) Radiation-sensitive elements

(75) Inventors: Harald Baumann, Osterode am Harz (DE); Michael Flugel, Osterode/Harz (DE); Udo Dwars, Herzberg am Harz (DE)

Correspondence Address: FAEGRE & BENSON;ATTN: PATENT DOCKING, 2200 WELLS FARGO CENTER, 90 SOUTH 7TH STREET, MINNEAPOLIS, MN, 55402-3901, US

(73) Assignee: Kodak Polychrome Graphics LLC, Norwalk, CT (US)

(21) Appl. No.: 10/536,507

(22) PCT Filed: Nov. 28, 2003
(86) PCT No.: PCT/EP03/13430

§ 371 Date: May 25, 2005

(30) Foreign Application Priority Data
Nov. 28, 2002 (DE) 10255663.6

(51) Int. Cl. G03C 1/76

(52) U.S. Cl. 430/270.1

(57) ABSTRACT

The invention relates to radiation-sensitive elements comprising an aluminum substrate that has been roughened electrochemically with hydrochloric acid, and a radiation-sensitive coating comprising a coumarin sensitizer (I), a coinitiator a free-radical polymerizable monomer one or more P—OH groups and a biuret oligomer.

The present invention relates to radiation-sensitive elements, in particular radiation-sensitive elements whose coating comprises a free-radical polymerizable monomer having at least one P—OH group and a biuret oligomer. The invention furthermore relates to a process for the production of such elements, a radiation-sensitive composition suitable for the production of such elements and a process for the production of an imaged element from such radiation-sensitive elements.

The technical field of lithographic printing is based on the immiscibility of oil and water, wherein the oily material or the printing ink is preferably accepted by the image area, and the water or fountain solution is preferably accepted by the non-image area. When an appropriately produced surface is moistened with water and a printing ink is applied, the background or non-image area accepts the water and repels the printing ink, while the image area accepts the printing ink and repels the water. The printing ink in the image area is then transferred to the surface of a material such as paper, fabric and the like, on which the image is to be formed. Generally, however, the printing ink is first transferred to an intermediate material, referred to as blanket, which then in turn transfers the printing ink onto the surface of the material on which the image is to be formed; this technique is referred to as offset lithography.

A frequently used type of lithographic printing plate precursor comprises a photosensitive coating applied onto a substrate on aluminum basis. The coating can react to radiation such that the exposed portion becomes so soluble that it is removed during the developing process. Such a plate is referred to as positive working. On the other hand, a plate is referred to as negative working if the exposed portion of the coating is hardened by the radiation. In both cases, the remaining image area accepts printing ink, i.e. is oleophilic, and the non-image area (background) accepts water, i.e. is hydrophilic. The differentiation between image and non-image areas takes place during exposure, for which a film is attached to the printing plate precursor under vacuum in order to guarantee good contact. The plate is then exposed by means of a radiation source. When a positive plate is used, the area on the film corresponding to the image on the plate is so opaque that the light does not affect the plate, while the area on the film corresponding to the non-image area is clear and allows light to permeate the coating, whose, solubility increases. In the case of a negative plate, the opposite takes place: The area on the film corresponding to the image on the plate is clear, while the non-image area is opaque. The coating beneath the clear film area is hardened due to the incident light, while the area not affected by the light is removed during developing. The light-hardened surface of a negative working plate is therefore oleophilic and accepts printing ink, while the non-image area that used to be coated with the coating removed by the developer is desensitized and therefore hydrophilic.

Photosensitive mixtures have been used for years in photopolymerizable compositions for the production of photosensitive materials such as e.g. soldering masks for printed circuits and printing plates. However, an improved sensitivity in particular in the visible spectral range is required for new and advanced applications (e.g. exposure by means of lasers) so that the exposure time can be shortened. From an economic point of view it is also important that low-intensity lasers can be used, which are less expensive and more reliable than high-intensity lasers. Therefore, efforts have been made for some time to increase the sensitivity of photosensitive mixtures to be used in photopolymerizable-compositions.

It is known that the free-radical polymerization of ethylenically unsaturated compounds can be initiated by irradiation with visible light in the presence of photoreducible dyes and reducing agents, e.g. amines (U.S. Pat. No. 3,097,096). EP-A-122 223 discloses photoinitiators and photopolymerizable compositions comprising metallocenes. The use of such metallocenes resulted in an increase in the sensitivity of the photopolymerizable layer and thus a reduction of the necessary irradiation time and the required power of the radiation source. Attempts were also made to obtain improved results from the use of metallocenes that had been modified further, e.g. in the documents EP-A401 165, U.S. Pat. No. 4,590,287, EP-A-255 486, EP-A-256 981 and U.S. Pat. No. 5,106,722.

Document DE-A40 08 815 describes a photopolymerizable mixture comprising a polymeric binder, a free-radical polymerizable compound with at least one polymerizable group and at least one photooxidizable group in the molecule and a metallocene compound as photoinitiator.

In order to further improve sensibility, it was tried to use a metallocene compound together with a coinitiator. For example, EP-B-269 573 discloses liquid mixtures of photoinitiators which are solutions of titanocene compounds in liquid photoinitiators of the type α-hydroxy- and α-aminoacetophenone derivatives.

DE-A-38 32 032 describes a photopolymerizable mixture comprising a polymeric binder, a free-radical polymerizable compound with at least one polymerizable group, a photoreducible dye, and, as initiator, a metallocene as well as a coinitiator. The coinitiator is a trihalogenomethyl compound divisible by radiation, which is intended to increase photosensitivity. Compounds with a triazine ring in the parent substance carrying two trihalogneomethyl groups are preferred.

DE-A40 13 358 describes a specific process for the production of printing forms or photoresists using metallocene compounds as photoinitiator, which is aimed at an improvement of sensitivity.

U.S. Pat. No. 3,717,558 describes metallocenes of subgroup elements in combination with a further photoinitiator comprising an activated halogen-containing group for the use in photopolymerizable recording materials. However, these initiator combinations are very sensitive to oxygen and hydrolysis and are therefore not suitable for the production of printing plates and resist materials.

The use of a combination of specific organometal compounds and onium salts in a hardening agent for polymerizable compounds is also known (U.S. Pat. No. 5,086,086). As metallocene compound, organometal compounds are used whose essential feature is that they comprise at least one metal-metal sigma bond, i.e. that at least two transition-metal atoms are present in one complex. The hardening agents described in U.S. Pat. No. 5,086,086 are not used together with dyes for light-induced polymerization.

U.S. Pat. No. 4,971,892 discloses photopolymerizable compositions which are particularly suitable for printing plates and are said to exhibit a high degree of sensitivity to visible light. As initiator system for free-radical polymerization, these photopolymerizable compositions comprise an initiator selected from diaryliodonium salts, halogenated triazines and triarylsulfonium salts, as well as a specific merocyanine dye.

U.S. Pat. No. 4,959,297 is directed to photopolymerizable compositions comprising at least one vinyl monomer capable of undergoing free-radical polymerization, a photoinitiator system, a diaryliodonium salt, a pigment, one or more electron donating compounds and additives. Finally, DE-A4,217,495 discloses a photopolymerizable mixture and a recording material produced therefrom.

DE-A-4,418,645 describes a photosensitive mixture comprising a binder, one or more polymerizable compounds with at least one polymerizable group and one or more dyes absorbing in the range of 250 nm to 700 nm, as well as an initiator system comprising at least one metallocene compound and at least one onium compound.

U.S. Pat. No. 4,147,552 describes photosensitive compositions comprising a compound with an olefinic double bond or an azide group, and a coumarin sensitizer.)

The use of coumarins, in particular ketocoumarins, in photosensitive compositions is also described in U.S. Pat. No. 5,011,755; in this document, the ketocoumarins are used together with titanocenes.

EP-A-0 738 928 describes compositions that can be polymerized with visible light. A mixture of a coumarin dye, an arylborate compound and a halogen-substituted s-triazine or diphenyliodonium salt is used as polymerization initiator.

In EP-A-0 747 771 as well, coumarins are used in combination with titanocenes in photosensitive compositions.

In EP-A-1 041 074, 4-cyanocoumarin derivatives and their use in photopolymerizable compositions are described, while EP-A-1 078 926 discloses 3-formylcoumarin derivatives for photopolymerizable compositions. U.S. Pat. Nos. 4,921,827, 4,965,171 and 4,971,892 describe photopolymerizable compositions comprising a merocyanine sensitizer and a diaryliodonium salt.

EP-A-0 793 145 describes a photosensitive lithographic printing plate precursor whose photosensitive coating comprises a monomer with a (meth)acryloyl group and a phosphate group, as well as a binder with carboxy groups. The aluminum substrate used in the printing plate precursor is electrochemically roughened prior to coating and subjected to an anodizing treatment; roughening is carried out with a hydrochloric acid electrolyte. However, it has been found that the adhesion of the coating on the substrate is insufficient, which results e.g. in low numbers of copies. In EP-A-0 851 299 efforts are made to solve this problem by applying a photosensitive coating comprising a monomer with a (meth)acryloyl group and a phosphate group onto an aluminum substrate that has been electrochemically roughened with a nitric acid electrolyte. However, lithographic printing plates whose aluminum substrates have been electrochemically roughened with nitric acid do not start up as quickly as plates whose substrates' have been electrochemically roughened with HCl. Moreover, from an ecological point of view, waste water polluted with small amounts of HNO₃ is more critical than waste water polluted with HCl.

Despite the progress that has already been made in improving the adhesion on the substrate and in increasing the sensitivity of photopolymerizable mixtures, there is still a need for mixtures with properties that have been improved even further, in particular excellent radiation sensitivity in combination with good storage stability.

It is the object of the present invention to provide novel radiation-sensitive elements exhibiting improved properties compared to the ones known in the prior art, in particular high photosensitivity (especially for exposure with violet laser diodes and FD-YAG lasers), high resolution in combination with good storage stability, good adhesion of the coating on the substrate and—in the case of printing plates—a quick start-up and yielding a large number of copies on the printing machine.

This problem is solved by providing a radiation-sensitive element comprising:
(a) an aluminum substrate which has been subjected to a pretreatment of electrochemical roughening and optionally subsequent anodizing and/or application of a hydrophilizing layer, wherein the electrochemical roughening is carried out with a hydrochloric acid electrolyte or an electrolyte essentially consisting of hydrochloric acid, and
(b) a radiation-sensitive coating comprising
   (i) at least one free-radical polymerizable monomer with at least one ethylenically unsaturated polymerizable group and at least one P—OH group,
   (ii) at least one sensitizer of the formula (I), 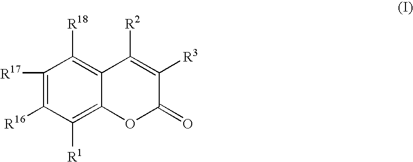
      wherein
      R¹, R¹⁶, R¹⁷ and R¹⁸ are independently selected from —H, a halogen atom, C₁-C₂₀ alkyl, —OH, —O—R⁴ and —NR⁵R⁶, wherein R⁴ is C₁-C₂₀ alkyl, C₅-C₁₀ aryl or C₆-C₃₀ aralkyl and R⁵ and R⁶ are independently selected from a hydrogen atom and C₁-C₂₀ alkyl,
      or R¹ und R¹⁶, R¹⁶ and R¹⁷ or R¹⁷ and R¹⁸ together form a 5- or 6-membered heterocyclic ring with a heteroatom, selected from N and O in one or both positions adjacent to the phenyl ring,
      or R¹⁶ or R¹⁷ forms, together with each of its two adjacent substituents, a 5- or 6-membered heterocyclic ring with a heteroatom, selected from N and O, in one or both positions adjacent to the phenyl ring, wherein each formed 5- or 6-membered heterocyclic ring can independently be substituted with one or more C₁-C₆ alkyl groups,
      with the proviso that at least one of R¹, R¹⁶, R¹⁷ and R¹⁸ is not hydrogen or C₁-C₂₀ alkyl,
      R² is a hydrogen atom, C₁-C₂₀ alkyl, C₅-C₁₀ aryl or C₆-C₃₀ aralkyl and
      R³ is a hydrogen atom or a substituent selected from —COOH, —COOR⁷, —COR⁸, —CONR⁹R¹⁰, —CN, C₅-C₁₀ aryl, C₆-C₃₀ aralkyl, a 5- or 6-membered heterocyclic group, a group —CH═CH—R¹² and 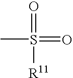
      wherein R⁷ is C₁-C₂₀ alkyl, R⁸ is C₁-C₂₀ alkyl or a 5- or 6-membered heterocyclic group, R⁹ and R¹⁰ are independently selected from a hydrogen atom and C₁-C₂₀ alkyl, R¹¹ is C₁-C₁₂ alkyl or alkenyl, a heterocyclic non-aromatic ring or C₅-C₂₀ aryl optionally with a heteroatom selected from O, S and N, and R¹² is C₅-C₁₀ aryl or a 5- or 6-membered heterocyclic, optionally aromatic, ring;
      or R² and R³, together with the carbon atoms to which they are bonded, form a 5- or 6-membered, optionally aromatic, ring;
   (iii) at least one coinitiator selected from an onium compound, a hexaarylbiimidazole compound and a trihalogenomethyl compound;
   (iv) at least one biuret oligomer of the formula (V) 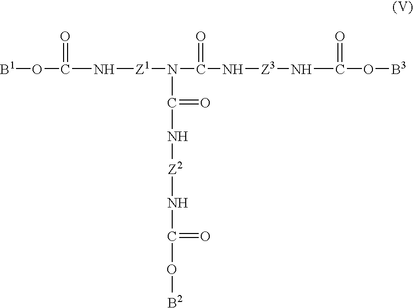
      wherein Z¹, Z² and Z³ are independently selected from C₂-C₁₈ alkanediyl and C₆-C₂₀ arylene,
      B¹, B² and B³ are independently selected from 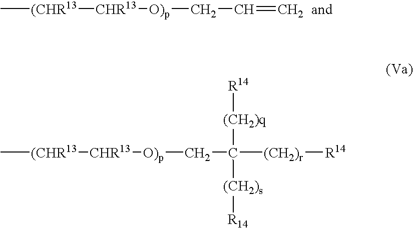
      wherein R¹³ is independently selected from a hydrogen atom and —CH₃ and p=0 or an integer from 1-10, each group R¹⁴ is independently selected from a hydrogen atom, a group 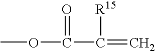
      and a group —O—CH₂—CH═CH₂,
      R¹⁵ is a hydrogen atom or C₁-C₁₂ alkyl and
      q, r and s independently of each other are 0 or 1,
      with the proviso that in each group B¹, B² and B³ at least one R¹⁴ is not a hydrogen atom if B¹, B² and B³ all represent a group of the formula (Va), and
   (v) optionally one or more metallocenes.

Unless indicated otherwise, the term “5- or 6-membered heterocyclic group” as used in the present invention refers to a saturated or unsaturated cyclic group wherein one or more carbon atoms are substituted with heteroatoms selected from O, S and N; preferably, one or two carbon atoms are substituted. Optionally, the heterocyclic rest can comprise one or more substituents. In the case of an unsaturated group, it can be an aromatic or a non-aromatic group.

Unless indicated otherwise, the terms “alkyl group, alkanediyl group or alkyl unit of an aralkyl group” as used in the present invention refer to a straight-chain, branched or cyclic saturated hydrocarbon group, which optionally comprises one or more substituents selected from halogen atoms (fluorine, chlorine, bromine, iodine), C₁-C₁₂ alkoxy, 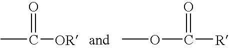
(wherein R′ is selected from C₁-C₁₂ alkyl).

Unless indicated otherwise, the terms “aryl group or aryl unit of an aralkyl group” as used in the present invention refer to a phenyl group or a phenyl group with one or more fused additional aromatic hydrocarbon rings wherein the phenyl ring and/or the fused rings optionally comprise one ore more substituents.

The shortened terms “(meth)acrylic acid” and “(meth)acrylate” refer to both acrylic acid and methyacrylic acid and methacrylate and acrylate, respectively.

The coumarin sensitizer of formula (I) is an essential component of the radiation-sensitive coating.

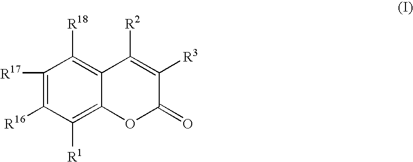

In this formula,

R¹, R¹⁶, R¹⁷ and R¹⁸ are independently selected from —H, a halogen atom, C₁-C₂₀ alkyl, —OH, —O—R⁴ and —NR⁵R⁶, wherein R⁴ is C₁-C₂₀ alkyl, C₅-C₁₀ aryl or C₆-C₃₀ aralkyl (preferably C₁-C₆ alkyl) and R⁵ and R⁶ are independently selected from a hydrogen atom and C₁-C₂₀ alkyl,

or R¹ and R¹⁶, R¹⁶ and R¹⁷ or R¹⁷ and R¹⁸ together form a 5- or 6-membered heterocyclic ring with a heteroatom, selected from N and O in one or both positions adjacent to the phenyl ring shown in formula (I),

or R¹⁶ or R¹⁷ forms, together with each of its two adjacent substituents, a 5- or 6-membered heterocyclic ring with a heteroatom, selected from N and O, in one or both positions adjacent to the phenyl ring shown in formula (I),

wherein each formed 5- or 6-membered heterocyclic ring can independently be substituted with one or more C₁-C₆ alkyl groups,

with the proviso that at least one of R¹, R¹⁶, R¹⁷ and R¹⁸ is not hydrogen or C₁-C₂₀ alkyl,

R² is a hydrogen atom, C₁-C₂₀ alkyl, C₅-C₁₀ aryl or C₆-C₃₀ aralkyl and

R³ is a hydrogen atom or a substituent selected from —COOH, —COOR⁷, —COR⁸, —CONR⁹R¹⁰, —CN, C₅-C₁₀ aryl, C₆-C₃₀ aralkyl, a 5- or 6-membered heterocyclic optionally benzofused group, a group —CH═CH—R¹² and

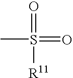

wherein R⁷ is C₁-C₂₀ alkyl, R⁸ is C₁-C₂₀ alkyl or a 5- or 6-membered heterocyclic group, R⁹ and R¹⁰ are independently selected from a hydrogen atom and C₁-C₂₀ alkyl, R¹¹ is C₁-C₁₂ alkyl or alkenyl, a heterocyclic non-aromatic ring or C₅-C₂₀ aryl optionally with a heteroatom, selected from O, S and N, and R¹² is C₅-C₁₀ aryl or a 5- or 6-membered heterocyclic, optionally aromatic, ring;

or R² and R³, together with the carbon atoms to which they are bonded, form a 5- or 6-membered, optionally aromatic, ring.

A sensitizer as referred to in the present invention is a compound which can absorb radiation when it is exposed but which cannot by itself, i.e. without the addition of coinitiators, form free radicals.

In one embodiment, one of R¹, R¹⁶, R¹⁷ and R¹⁸ is a group —NR⁵R⁶, and especially preferred a dimethylamino group or a diethylamino group. Preferably, the other groups are then all hydrogen atoms.

In another embodiment, R¹ and R¹⁶, R¹⁶ and R¹⁷ or R¹⁷ and R¹⁸ together form a 5- or 6-membered, preferably 6-membered, heterocyclic ring with a heteroatom selected from N and O (preferably N) in one or both positions (preferably one) adjacent to the phenyl ring; preferably, the formed heterocyclic ring is a saturated 6-membered ring with a nitrogen atom. In this embodiment, the remaining groups (R¹⁷ and R¹⁸, R¹ and R¹⁸ or R¹ and R¹⁶) preferably represent hydrogen atoms. The formed heterocyclic ring can comprise one or more substituents, independently selected from C₁-C₆ alkyl groups (preferably CH₃), which are preferably not bonded at the heteroatom.

According to another embodiment, R¹⁶ or R¹⁷ forms, together with each of its two adjacent substituents, a 5- or 6-membered (preferably 6-membered) heterocyclic ring with a heteroatom selected from N and O (preferably N), in one or both positions (preferably one) adjacent to the phenyl ring; preferably, the two formed heterocyclic rings are two saturated 6-membered rings with a common nitrogen atom, i.e. the two formed heterocyclic rings, together with the phenyl ring shown in formula (I), form a julolidine unit. In this embodiment, the remaining group (R¹⁸ or R¹) preferably represents a hydrogen atom. The two formed heterocyclic rings, which preferably represent a julolidine unit together with the phenyl ring, can be substituted with one or more substituents, whereby the substituents are independently selected from C₁-C₆ alkyl groups (preferably —CH₃).

The substituent R² is preferably a hydrogen atom or an optionally substituted C₁-C₆ alkyl, especially preferred H; —CH₃ or —CF₃.

R³ is preferably an acceptor substituent selected from —COOH, —COOCH₂CH₃, —COOCH₃, —CN and —CO—CH₃.

Examples of the most preferred sensitizers of formula (I) include the following:

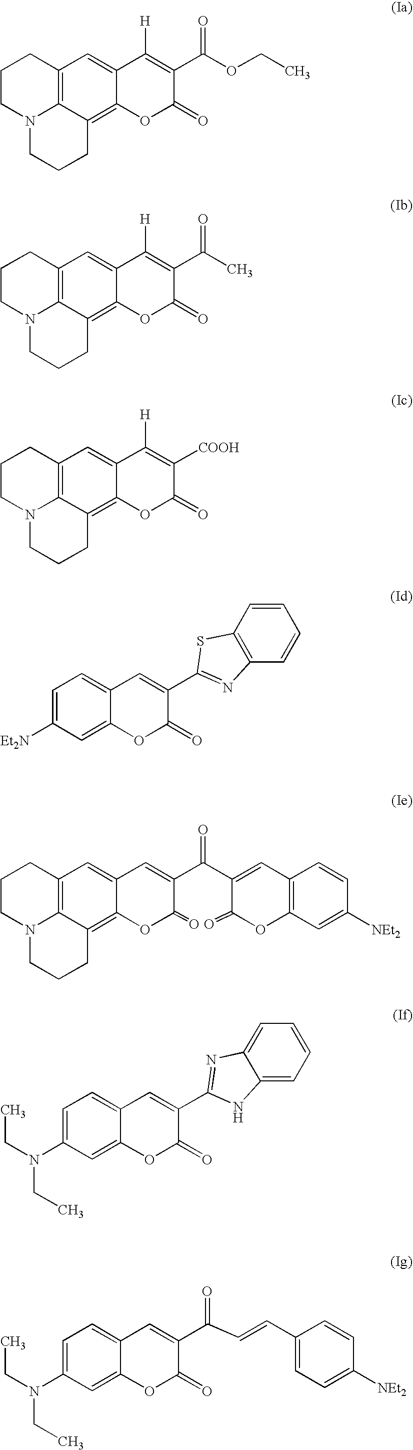

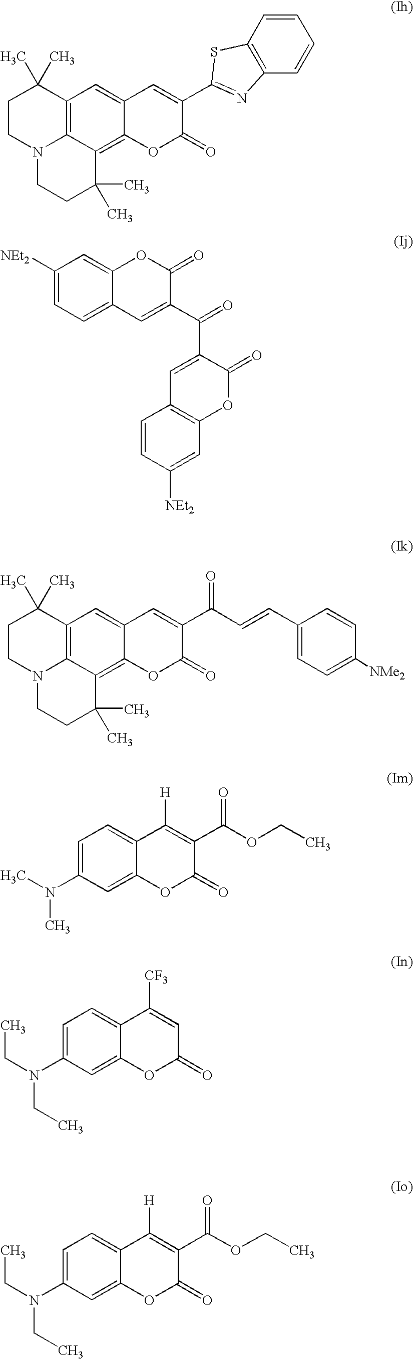

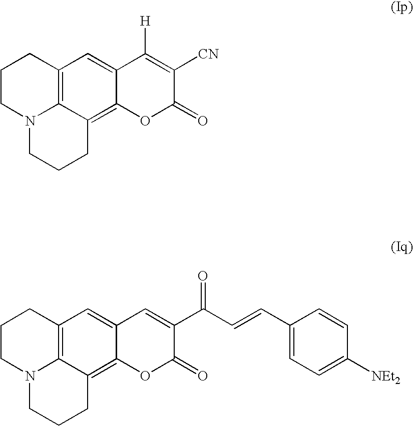

The amount of sensitizer(s) is not particularly restricted, however, it is preferably in the range of 0.2 to 15 wt.-%, based on the dry layer weight, especially preferred 0.5 to 10 wt.-%;

A coinitiator as referred to in the present invention is a compound that is essentially unable to absorb when exposed and forms free radicals together with the light-absorbing sensitizers.

In the present invention, onium compounds, hexaarylbiimidazole compounds, trihalogenomethyl compounds or mixtures thereof are used as coinitiators. Suitable onium salts are for example mentioned in U.S. Pat. No. 5,086,086. Of the possible onium salts mentioned in this document, iodonium, sulfonium, phosphonium, N-substituted N-heterocyclic onium salts or diazonium salts are preferred. Diaryliodonium salts, triarylsulfonium salts, aryldiazonium salts and alkoxy-pyrridinium salts should be mentioned in this connection. Especially preferred are diaryliodonium salts (most preferred are diphenyliodonium salt, di(alkylphenyl)iodonium salt, mono- or di-alkoxy-substituted iodonium salts) or an alkoxypyrridinium salt (most preferred are N-alkoxy-picolinium salt, N-alkoxy-4-phenylpyrridinium salt). The selection of the counterion of the onium salt is not particularly critical, suitable counterions include e.g. chloride, bromide, t-toluene sulfonate, mesitylene sulfonate, hexafluorophosphate, tetrafluoroborate, hexafluoroarsenate and hexafluoroantimonate. Examples of specific onium salts include: Diphenyliodoniumchloride, 4,4′-dicumyl-iodoniumchloride, N-methoxy-α-picolinium-p-toluenesulfonate, 4-methoxybenzol-diazonium-tetrafluoroborate, 4,4′-bis-dodecylphenyliodoniumhexafluorophosphate, 2-cyanoethyl-triphenylphosphonium-chloride and bis-[4-diphenylsulfonium-phenyl]sulfide-bis-hexafluorophosphate.

Suitable 2,2′,4,4′,5,5′-hexaarylbiimidazoles (in the following referred to as hexaarylbiimidazoles) can be represented by the following formula (IV): 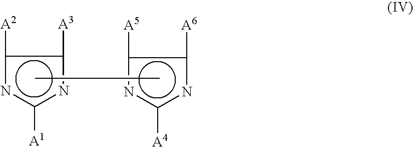
wherein A¹-A⁶ are substituted or unsubstituted C₅-C₂₀ aryl groups which are identical or different from each other and in whose rings one or more carbon atoms can optionally be substituted by heteroatoms selected from O, N and S. Suitable substituents for the aryl groups are those that do not inhibit the light-induced dissociation to triarylimidazolyl radicals, e.g. halogen atoms (fluorine, chlorine, bromine, iodine), —CN, C₁-C₆ alkyl (optionally with one or more substituents selected from halogen atoms, —CN and —OH), C₁-C₆ alkoxy, C₁-C₆ alkylthio, (C₁-C₆ alkyl) sulfonyl.

Preferred aryl groups are substituted and unsubstituted phenyl, biphenyl, naphthyl, pyridyl, furyl and thienyl groups. Especially preferred are substituted and unsubstituted phenyl groups, and particularly preferred are halogen-substituted phenyl groups.

Examples include:
2,2′-Bis(bromophenyl)-4,4′, 5,5′-tetraphenylbiimidazole,
2,2′-bis(p-carboxyphenyl)-4,4′,5,5″-tetraphenylbiimidazole,
2,2′-bis(o-chlorophenyl)-4,4′,5,5′-tetrakis(p-methoxyphenyl)-biimidazole,
2,2′-bis(p-chlorophenyl)-4,4′,5,5′-tetrakis(p-methoxyphenyl)-biimidazole,
2,2′-bis(p-cyanophenyl)-4,4′5,5′-tetrakis(p-methoxyphenyl)-biimidazole,
2,2′-bis(2,4-dichlorophenyl)-4,4′,5,5′-tetraphenylbiimidazole,
2,2′-bis(2,4-dimethoxyphenyl)-4,4′,5,5′-tetraphenylbiimidazole,
2,2′-bis(o-ethoxyphenyl)-4,4′,5,5′-tetraphenylbiimidazole,
2,2′-bis(m-fluorophenyl)-4,4′,5,5′-tetraphenylbiimidazole,
2,2′-bis(o-fluorophenyl)-4,4′,5,5′-tetraphenylbiimidazole,
2,2′-bis(p-fluorophenyl)-4,4′,5,5′-tetraphenylbiimidazole,
2,2′-bis(o-hexoxyphenyl)-4,4′,5,5′-tetraphenylbiimidazole,
2,2′-bis(o-hexylphenyl)-4,4′,5,5′-tetrakis(p-methoxyphenyl)-biimidazole,
2,2′-bis(3,4-methylenedioxyphenyl)-4,4′,5,5′-tetraphenylbiimidazole,
2,2′-bis(o-chlorophenyl)-4,4′,5,5′-tetrakis(m-methoxyphenyl)biimidazole,
2,2′-bis(o-chlorophenyl)-4,4′,5,6′-tetrakis[m-(betaphenoxy-ethoxyphenyl)]-biimidazole,
2,2′-bis(2,6-dichlorophenyl)-4,4′,5,5′-tetraphenylbiimidazole,
2,2′-bis(o-methoxyphenyl)-4,4′,5,5′-tetraphenylbiimidazole,
2,2′-bis(p-methoxyphenyl)-4,4′-bis(o-methoxyphenyl)-5,5′-diphenylbiimidazole,
2,2′-bis(o-nitrophenyl)-4,4′,5,5′-tetraphenylbiimidazole,
2,2′-bis(p-phenylsulfonylphenyl)-4,4′,5,5′-tetraphenylbiimidazole,
2,2′-bis(p-sulfamoylphenyl)-4,4′,5,5′-tetraphenylbiimidazole,
2,2′-bis(2,4,5-trimethylphenyl)-4,4′,5,5′-tetraphenylbiimidazole,
2,2′-di-4-biphenylyl-4,4′,5,5′-tetraphenylbiimidazole,
2,2′-di-1-naphthyl-4,4′,5,5′-tetrakis(p-methoxyphenyl)-biimidazole,
2,2′-di-9-phenanthryl-4,4′,5,5′-tetrakis(p-methoxyphenyl)-biimidazole,
2,2′-diphenyl-4,4′,5,5′-tetra-4-biphenylylbiimidazole,
2,2′-diphenyl-4,4′,5,5′-tetra-2,4-xylylbiimidazole,
2,2′-di-3-pyridyl-4,4′,5,5′-tetraphenylbiimidazole,
2,2′-di-3-thienyl-4,4′,5,5′-tetraphenylbiimidazole,
2,2′-di-o-tolyl-4,4′,5,5′-tetraphenylbiimidazole,
2,2′-di-p-tolyl-4,4′-di-o-tolyl-5,5′-diphenylbiimidazole,
2,2′-di-2,4-xylyl-4,4′,5,5′-tetraphenylbiimidazole,
2,2′,4,4′,5,5′-hexakis(p-benylthiophenyl)biimidazole,
2,2′,4,4′,5,5′-hexa-1-naphthylbiimidazole,
2,2′,4,4′,5,5′-hexaphenylbiimidazole,
2,2′-bis(2-nitro-5-methoxyphenyl)-4,4′,5,5′-tetraphenylbiimidazole, and
2,2′-bis(o-nitrophenyl)-4,4′,5,5′-tetrakis(m-methoxyphenyl)biimidazole,
2,2′-bis(2-chloro-5-sulfophenyl)-4,4′,5,5′-tetraphenylbiimidazole,
   and especially preferred:
2,2′-bis(o-chlorophenyl)-4,4′,5,5′-tetraphenylbiimidazole,
2,2′-bis(o-chlorophenyl)-4,4′,5,5′-tetra(p-fluorophenyl)biimidazole,
2,2′-bis(o-bromophenyl)-4,4′,5,5′-tetra(p-iodophenyl)biimidazole,
2,2′-bis(o-chlorophenyl)-4,4′,5,5′-tetra(p-chloronaphthyl)biimidazole,
2,2′-bis(o-chlorophenyl)-4,4′,5,5′-tetra(p-chlorophenyl)biimidazole,
2,2′-bis(o-bromophenyl)-4,4′,5,5′-tetra(p-chloro-p-methoxyphenyl)biimidazole,
2,2′-bis(o-chlorophenyl)-4,4′,5,5′-tetra(o,p-dichlorophenyl)biimidazole,
2,2′-bis(o-chlorphenyl)-4,4′,5,5′-tetra(o,p-dibromophenyl)biimidazole,
2,2′-bis(o-bromphenyl)-4,4′,5,5′-tetra(o,p-dichlorophenyl)biimidazole or
2,2′-bis(o,p-dichlorphenyl)-4,4′,5,5′,-tetra(o,p-dichlorophenyl)biimidazole;
   however, the invention is not restricted to those compounds.

Suitable hexyarylbiimidazoles can be prepared according to known methods (see e.g. U.S. Pat. No. 3,445,234). A preferred method is the oxidative dimerization of corresponding triarylimidazoles with hexacyanoferrate (III) in an alkaline solution.

It is irrelevant for the purpose of the present invention which hexaarylbiimidazole isomer (or mixture of isomers) is used (e.g. 1,2′, 1,1′, 1,4′, 2,2′, 2,4′ and 4,4′ isomers) as long as it is capable of undergoing photodissociation and providing triarylimidazolyl radicals in the process.

The trihalogenomethyl compounds that can be used as coinitiators are capable of forming radicals. Trihalogenomethyl-substituted triazines and trihalogenomethyl-arylsulfones are preferred. Examples include the following (without restricting the invention to these compounds):
2-(4-Methoxyphenyl)-4,6-bis(trichloromethyl)-s-triazine,
2-(4-chlorophenyl)-4,6-bis-(trichloromethyl)-s-triazine,
2-phenyl-4,6-bis(trichloromethyl)-s-triazine,
2,4,6-tri-(trichloromethyl)-s-triazine,
2,4,6-tri-(tribromomethyl)-s-triazine and
tribromomethylphenylsulfone.

One coinitiator or a mixture of coinitiators can be used. The amount of coinitiator(s) is not particularly restricted; however, it is preferably in the range of 0.2 to 25 wt.-%, based on the dry layer weight, especially preferred 0.5 to 15 wt.-%.

The free-radical polymerizable monomer used in the present invention-comprises at least one ethylenically unsaturated free-radical polymerizable groups and at least one P—OH group (in the following also referred to as “P—OH monomer” in short). Preferably, this monomer is represented by the following formula (II) or (III): 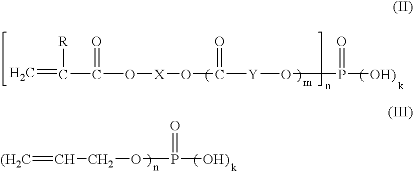
wherein n is 1 or 2, m is 0 or 1, k is 1 or 2, n+k=3, R represents C₁-C₁₂ alkyl (preferably C₁-C₄ alkyl, especially preferred methyl), X represents C₂-C₁₂ alkanediyl (preferably C₂-C₄ alkanediyl, especially preferred —CH₂CH₂—) and Y is C₂-C₁₂ alkanediyl (preferably C₂-C₈ alkanediyl, especially preferred —(CH₂)₅—). Suitable P—OH monomers are also described in the prior art, e.g. in U.S. Pat. No. 3,686,371. The P—OH monomers of formula (II) can for example be prepared by esterification of phosphoric acid with an appropriate amount of (meth)acrylate comprising hydroxy groups. Hydroxyalkyl(meth)acrylates are especially preferred for this purpose.

In addition to the (meth)acrylic acid derivatives of formula (II), allylphosphates of formula (III), as described e.g. in U.S. Pat. No. 3,686,371, can also be used.

One kind of P—OH monomer or a mixture of different kinds can be used. The amount of P—OH monomer is not particularly restricted, however, it is preferably 0.2 to 30 wt.-%, based on the dry layer weight, especially preferred 0.5 to 15 wt.-%.

Another essential component of the radiation-sensitive coating is the biuret oligomer of the formula (V) 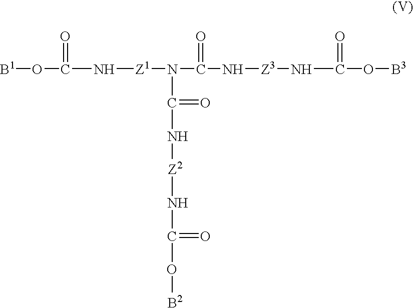
wherein Z¹, Z² and Z³ are independently selected from C₂-C₁₈ alkanediyl and C₆-C₂₀ arylene,

B¹, B² and B³ are independently selected from 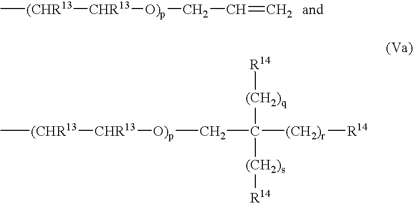
wherein R¹³ is independently selected from a hydrogen atom and —CH₃ and p=0 or an integer from 1-10, each group R¹⁴ is independently selected from a hydrogen atom, a group

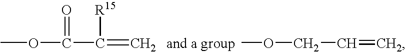

R¹⁵ is a hydrogen atom or C₁-C₁₂ alkyl and

q, r and s independently of each other are 0 or 1,

with the proviso that in each group B¹, B² and B³ at least one R¹⁴ is not a hydrogen atom if B¹, B² and B³ all represent a group of the formula (Va).

In the biuret oligomer of formula (V), Z¹, Z² and Z³ are independently selected from C₂-C₁₈ alkanediyl (preferably C₂-C₈ alkanediyl, especially preferred hexamethylene) and C₆-C₂₀ arylene (preferably phenylene or naphthylene). It is preferred that Z¹=Z²=Z³.

In one embodiment, the biuret oligomer is obtained by reacting at least one acrylate or methacrylate comprising one or more hydroxy groups with the biuret of hexamethylene diisocyanate.

B¹, B² and B³ are independently selected from

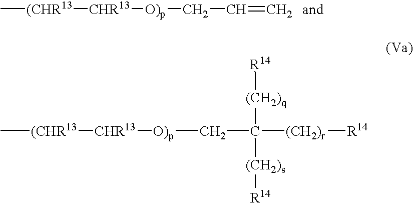

When B¹, B² and B³ all represent a group of the formula (Va) it is important that in each group B¹, B² and B³ at least one R¹⁴ is not a hydrogen atom so that a C—C double bond is present.

R¹⁵ is a hydrogen atom or C₁-C₁₂ alkyl, preferably a hydrogen atom or C₁-C₄ alkyl, especially preferred a hydrogen atom or a methyl group.

R¹³ is independently selected from a hydrogen atom and CH₃; preferably, both R¹³ are hydrogen atoms or one R¹³ is a hydrogen atom and the other CH₃.

p is an integer from 0 to 10, preferably 0.

If R¹⁴ is not a hydrogen atom, R¹⁴ is preferably a methacrylate or acrylate group.

q, r and s are independently 0 or 1; it is preferred that q=r=s, especially preferred that q=r=s=1.

In a preferred embodiment, B¹, B² and B³ can independently be derived from hydroxyethyl(meth)acrylate or pentaerythritol which has been esterified with (meth)acrylic acid three times.

The biuret oligomer of formula (V) can be prepared as follows:

In a first step, the biuret parent structure is prepared by reacting at least one diisocyanate of the formula
O═C═N-Z-N═C═O
(wherein Z is defined as Z¹, Z² and Z³) with an appropriately selected amount of water, usually 3 moles diisocyanate(s) and 1 mole water (cf. e.g. DE-B-1,101,394 and Houben-Weyl, Methoden der organischen Chemie [methods in organic chemistry], 4th edition (1963), Vol. 14/2, pages 69 et seqq.). The reaction is preferably carried out without a solvent.

In a second step, the terminal isocyanate groups are reacted with at least one unsaturated compound comprising one or more hydroxy groups selected from 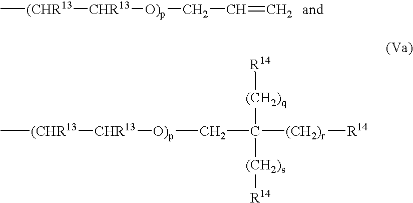
wherein R¹⁴, R¹³, p, q, r and s are defined as above.

If the biuret is reacted with several compounds comprising OH groups, the reaction can be carried out in stages (i.e. the unsaturated compounds are reacted with the biuret one after the other) or simultaneously (i.e. the unsaturated compounds are all reacted with the biuret at the same time).

The reaction is usually carried out in aprotic solvents such as e.g. benzene, toluene, xylene, a ketone (e.g. methylethylketone) or an ester (e.g. butyl acetate) in the presence of a catalyst (e.g. tertiary amines or tin organyls such as dibutyltin dilaurate and dioctyltin dilaurate) and an inhibitor for preventing thermal polymerization at a temperature between room temperature and about 80° C.

Subsequently, a low alcohol (e.g. methanol or ethanol) can be added if needed to react with unreacted isocyanate.

By appropriately selecting the molar ratio of the unsaturated compounds, the ratio of the different groups B¹, B² and B³ can be controlled. Details regarding the preparation of the oligomers A can be inferred from e.g. DE-A-2,361,041.

The radiation-sensitive coating can comprise one or more kinds of the biuret oligomer.

The amount of biuret oligomer in the radiation-sensitive layer is not particularly restricted, however, it is preferably present in an amount of 5 to 85 wt.-% (especially preferred 10 to 70 wt.-%), based on the dry layer weight.

In addition to the above-mentioned essential components, the radiation-sensitive coating can optionally comprise one or several metallocenes. Metallocenes of elements of the fourth subgroup of the periodic table of the elements are preferred, in particular compounds with titanium or zirconium as a central atom; apart from the document EP-A-122 223, these compounds are also described in numerous other documents, such as EP-A-119 162, EP-A-1 86 626, EP-A-242 330, EP-A-255 486, EP-A-256 981 and EP-A-269 573. Metallocene compounds comprising a titanium or zirconium atom as central atom and furthermore four aromatic ligands are especially preferred. Particularly preferred are those metallocene compounds in which two ligands represent optionally substituted cyclopentadienyl groups and two ligands represent six-membered aromatic groups optionally comprising at least one ortho fluorine atom and optionally also a 1-pyrryl group. Most preferred is a metallocene compound wherein the substituted phenyl groups comprise halogen atoms. Phenyl groups which comprise at least one fluorine atom in the o-position and which can furthermore be substituted with halogen atoms, alkyl or alkoxy groups with one to four carbon atoms and/or an optionally etherified or esterified polyoxyalkylene group are also preferred. The polyoxyalkylene group usually comprises one to six oxyalkylene units.

The metallocenes that can be used in the present invention are either commercially available, such as e.g. bis(cyclopentadienyl)-bis-[2,6-difluoro-3-(pyrr-1-yl)-phenyl]-titanium (available from the company Ciba Specialities, Switzerland), which is especially preferred in the present invention, or can be prepared according to processes described in the prior art (e.g. in EP-A-122 223). Further metallocenes are for example described in U.S. Pat. No. 3,717,558, U.S. Pat. No. 4,590,287 and U.S. Pat. No. 5,106,722.

Examples of suitable titanocenes include the following without restricting the present invention to these compounds:
Bis(cyclopentadienyl)-bis(pentafluorophenyl)-titanium
bis(cyclopentadienyl)-bis(3-bromo-tetrafluorophenyl)-titanium
bis(cyclopentadienyl)-bis(4-bromo-tetrafluorophenyl)-titanium
bis(cyclopentadienyl)-bis(2,4,5,6-tetrafluorophenyl)-titanium
bis(cyclopentadienyl)-bis(3,5-dichloro-2,4,6-trifluorophenyl)-titaniumbis(cyclopentadienyl)-bis(4-morpholino-tetrafluorophenyl)-titanium
bis(cyclopentadienyl)-bis(4-[4′-methylpiperazino]-tetrafluorophenyl)-titanium
bis(cyclopentadienyl)-bis(4-dibutylamino-tetrafluorophenyl)-titanium
bis(cyclopentadienyl)-bis(2,4,6-trifluorophenyl)-titanium
bis(methylcyclopentadienyl)-bis(pentafluorophenyl)-titanium
bis(methylcyclopentadienyl)-bis(4-morpholino-tetrafluorophenyl)-titanium
bis(methylcyclopentadienyl)-bis(4-[4′-methylpiperazino]-tetrafluorophenyl)-titanium
bis(cyclopentadienyl)-bis(4-[dimethylaminomethyl]-tetrafluorophenyl)-titanium
bis(cyclopentadienyl)-bis(2,3,5,6-tetrafluorophenyl)-titanium
bis(methylcyclopentadienyl)-bis(2,8,6,6-tetrafluorophenyl)-titanium
bis(methylcyclopentadienyl)-bis(2,4,6-trifluorophenyl)-titanium
bis(cyclopentadienyl)bis(2,3,6-trifluorophenyl)-titanium
bis(methylcyclopentadienyl)-bis(2,6-difluorophenyl)-titanium
bis(cyclopentadienyl)-bis(2,6-difluoro-3-methoxy-phenyl)-titanium
bis(cyclopentadienyl)-bis(2,6-difluoro-3-propoxy-phenyl)-titanium
bis(cyclopentadienyl)-bis(2,6-difluoro-3-hexyloxy-phenyl)-titanium
bis(cyclopentadienyl)-bis[2,6-difluoro-3-(2-ethoxy-ethoxy)phenyl]-titanium
bis(cyclopentadienyl)-bis(2,6-difluoro-3-methylphenyl)-titanium
bis(cyclopentadienyl)-bis(4-methoxy-tetrafluorophenyl)-titanium
bis(cyclopentadienyl)-bis(4-butoxy-tetrafluorophenyl)-titanium
bis(cyclopentadienyl)-bis(4-isopropoxy-tetrafluorophenyl)-titanium
bis(cyclopentadienyl)-bis(4-[2-ethylhexyloxy]-tetrafluorophenyl)-titanium
bis(cyclopentadienyl)-bis(4-decyloxy-tetrafluorophenyl)-titanium
bis(cyclopentadienyl)-bis(4-dodecyloxy-tetrafluorophenyl)-titanium
bis(cyclopentadienyl)-bis(4-octyloxy-tetrafluorophenyl)-titanium
bis(methylcyclopentadienyl)-bis(4-octyloxy-tetrafluorophenyl)-titanium
bis(methylcyclopentadienyl)-bis(4-decyloxy-tetrafluorophenyl)-titanium
bis(methylcyclopentadienyl)-bis(4-dodecyloxy-tetrafluorophenyl)-titanium
bis(methylcyclopentadienyl)-bis(4-butoxy-tetrafluorophenyl)-titanium
bis(methylcyclopentadienyl)-bis(4-ethoxy-tetrafluorophenyl)-titanium
bis(methylcyclopentadienyl)-bis(4-isopropoxy-tetrafluorophenyl)-titanium
bis(methylcyclopentadienyl)-bis(4-dibutylamino-tetrafluorophenyl)-titanium
bis(cyclopentadienyl)-bis(2,6-difluorophenyl)-titanium
bis(cyclopentadienyl)-bis(2,4,5-trifluorophenyl)-titanium
bis(cyclopentadienyl)-bis(2,3-difluorophenyl)-titanium
bis(cyclopentadienyl)-bis(2,5-difluorophenyl)-titanium
bis(cyclopentadienyl)-bis(2,3,4,5-tetrafluorophenyl)-titanium
bis(methylcyclopentadienyl)-bis(2,3,4,5-tetrafluorophenyl)-titanium
bis(methylcyclopentadienyl)-bis(2,3,4,6-tetrafluorophenyl)-titanium
bis(methylcyclopentadienyl)-bis(2,3,6-trifluorophenyl)-titanium
bis(dimethylcyclopentadienyl)-bis(pentafluorophenyl)-titanium
bis(cyclopentadienyl)-3,4,5,6,3′,4′,5′,6′-octafluorodiphenylsulfide-2,2′-diyl-titanium
bis(cyclopentadienyl)-bis(4-[4,4-dimethylpiperazino]-tetrafluorophenyl)-titanium-diiodide
bis(cyclopentadienyl)-bis(4-[trimethylammonium-methyl]-tetrafluorophenyl)-titanium-diiodide

Suitable zirconocenes are e.g. analogues of the above-mentioned titanocenes, i.e. the compounds mentioned above comprising zirconium instead of titanium.

In the present invention, one metallocene or a mixture of metallocenes can be used. The amount of metallocene(s) is not particularly restricted, however, it is preferably in the range of 0 to 20 wt.-%, based on the dry layer weight, especially preferred 0 to 10 wt.-%.

In addition to the above-mentioned free-radical polymerizable monomers having Pt least one P—OH group, other monomers/oligomers can be used which comprise an ethylenically unsaturated free-radical polymerizable group. Examples thereof include acrylic acid and methacrylic acid or their derivatives, which comprise one or more unsaturated groups. Esters of acrylic acid and methacrylic acid in the form of monomers, oligomers and prepolymers should particularly be mentioned in this connection. They can be used in solid or liquid form, wherein solid and highly viscous forms are preferred. Examples include the following monomers: Trimethylolpropanetri(meth)acrylate, pentaerythritoltri(meth)acrylate, dipentaerythritolmonohydroxypenta(meth)acrylate, dipentaerythritolhexa(meth)acrylate, pentaerythritoltetra(meth)acrylate, di(trimethylolpropane)tetra-(meth)acrylate, diethyleneglycoldi(meth)acrylate, triethyleneglycoldi(meth)acrylate and tetraethyleneglycoldi(meth)acrylate. The term (meth)acrylate used above is an abbreviated term indicating acrylate and methacrylate. Suitable oligomers and/or prepolymers include e.g. urethane(meth)acrylate, epoxy(meth)acrylate, polyester(meth)acrylate, polyether(meth)acrylate and unsaturated polyester resins.

The amount of additional monomers/oligomers/prepolymers is not particularly restricted, however, it is preferably 0 to 80 wt.-%, based on the dry layer weight, and an amount of 10 to 60 wt.-% is especially preferred. The ratio of P—OH monomers used in the present invention to additional polymerizable monomers/oligomers/prepolymers is not particularly restricted; however, the amount of P—OH monomer is preferably lower than that of the additional monomers/oligomers/prepolymers (if they are present).

Optionally, the photosensitive composition of the present invention can also comprise an alkali-soluble binder or a mixture of such binders. The binder is preferably selected from polyvinyl acetals, acrylic polymers and polyurethanes. It is preferred that the binder contain acid groups, especially preferred carboxy groups. Most preferred are acrylic acid binders. Binders with acid groups preferably have acid numbers in the range of 20 to 180 mg KOH/g polymer. Optionally, the binder can comprise unsaturated groups in the main chain or the side chains. Such unsaturated bonds are capable of undergoing a free-radical photopolymerization reaction or another photoreaction such as e.g. a 2+2-photocycloaddition.

The alkali-soluble binder is preferably present in an amount of 0 to 80 wt.-%, based on the dry layer weight, especially preferred in an amount of 5 to 50 wt.-%.

The photosensitive composition of the present invention can optionally also comprise small amounts of a thermopolymerization inhibitor in order to prevent an unnecessary thermopolymerization of the ethylenically unsaturated monomer during the production or storage of the photosensitive composition. Suitable examples of thermopolymerization inhibitors include hydroquinone, p-methoxyphenol, di-t-butyl-p-cresol, pyrrogallol, t-butylcatechol, benzoquinone, 4,4′-thio-bis-(3-methyl-6-t-butyl-phenol), 2,2′-methylene-bis-(4-methyl-6-t-butylphenol) and N-nitrosophenylhydroxyl-amine salts. The amount of thermopolymerization inhibitor in the photosensitive composition of the present invention is preferably 0 to 5 wt.-%, based on the dry layer weight, especially preferred 0.01 to 2 wt.-%.

Furthermore, the photosensitive layer of the present invention can comprise dyes or pigments for coloring the layer. Examples of colorants include e.g. phthalocyanine pigments, azo pigments, carbon black and titanium dioxide, ethyl violet, crystal violet, azo dyes, anthraquinone dyes and cyanine dyes. The amount of colorant is preferably 0 to 20 wt.-%, based on the dry layer weight, especially preferred 0.5 to 10 wt.-%.

For improving the physical properties of the hardened layer, the inventive photosensitive composition can additionally comprise further additives such as plasticizers or inorganic fillers. Suitable plasticizers include e.g. dibutyl phthalate, dioctyl phthalate, didodecyl phthalate, dioctyl adipate, dibutyl sebacate, triacetyl glycerin und tricresyl phosphate. The amount of plasticizer is not particularly restricted, however, it is preferably 0 to 10 wt.-%, based on the dry layer weight, especially preferred 0.25 to 5 wt.-%.

The radiation-sensitive coating can also comprise known chain transfer agents such as e.g. mercapto compounds. They are preferably used in an amount of 0 to 15 wt.-%, based on the dry layer weight, especially preferred 0.5 to 5 wt.-%.

Furthermore, the radiation-sensitive coating can comprise leuco dyes such as e.g. leuco crystal violet and leucomalachite green. They are preferably present in an amount of 0 to 10 wt.-%, based on the dry layer weight, especially preferred 0.5 to 5 wt.-%.

Additionally, the radiation-sensitive coating can comprise surfactants. Suitable surfactants include siloxane-containing polymers, fluorine-containing polymers and polymers with ethylene oxide and/or propylene oxide groups. They are preferably present in an amount of 0 to 10 wt.-%, based on the dry layer weight, especially preferred 0.2 to 5 wt.-%.

Further optional components of the radiation-sensitive coating include inorganic fillers such as e.g. Al₂O₃ and SiO₂. They are preferably present in an amount of 0 to 20 wt.-%, based on the dry layer weight, especially preferred 0.1 to 5 wt.-%.

The radiation-sensitive elements of the present invention can for example be printing plate precursors (in particular precursors of lithographic printing plates), printed circuit boards for integrated circuits or photomasks.

The substrate is an aluminum plate or foil; it is remarkably dimensionally stable and inexpensive, and furthermore exhibits excellent adhesion to the coating. The term “aluminum substrate” as used in the present invention also encompasses a composite film, wherein an aluminum foil is laminated onto a polyethylene terephthalate film.

The aluminum substrate or the aluminum surface of the laminate is electrochemically roughened with a hydrochloric acid electrolyte; subsequently, the substrate can optionally be subjected to an anodizing treatment or the application of a hydrophilizing layer. Within the framework of the present invention, the hydrochloric acid electrolyte used for electrochemical roughening denotes an electrolyte consisting of aqueous hydrochloric acid (e.g. 0.1 to 5 wt.-%) or essentially consists thereof; further components of the electrolyte include e.g. acetic acid, boric acid and sulfuric acid in an amount of at most 1 wt.-%. In any case, the electrolyte is free of nitric acid. For electrochemical roughening, the electrolyte is preferably heated to a temperature in the range of 20 to 90° C. The current density applied in the process is preferably 10-140 A/dm².

For improving the hydrophilic properties of the surface of the roughened metal substrate that has optionally been anodized in sulfuric acid or phosphoric acid, the substrate can be subjected to an aftertreatment with an aqueous solution of sodium silicate, calcium zirconium fluoride; polyvinylphosphonic acid or phosphoric acid.

The details of the above-mentioned substrate pretreatment are well known to the person skilled in the art.

The application of the radiation-sensitive composition can be carried out by means of common processes, e.g. coating by means of doctor blades, spray coating and centrifugal coating.

The additional application of a water-soluble oxygen-impermeable overcoat onto the photosensitive layer can be advantageous. The polymers suitable for such an overcoat include, inter alia, polyvinyl alcohol, polyvinyl alcohol/polyvinyl acetate copolymers, polyvinyl pyrrolidone, polyvinyl pyrrolidone/polyvinyl acetate copolymers and gelatin. The layer weight of the overcoat can e.g. be 0.1 to 4 g/m², preferably 0.3 to 3 g/m². However, the printing plate precursors according to the present invention show excellent properties even without an overcoat. The overcoat can also comprise matting agents (i.e. organic or inorganic particles with a particle size of 2 to 20 μm) which facilitate the planar positioning of the film during contact exposure.

The thus produced printing plate precursors are exposed in a manner known to the person skilled in the art with radiation of an appropriate wavelength and subsequently developed with a commercially available aqueous alkaline developer. The developed plates can be treated with a preservative (“gumming”) using a common method. The preservatives are aqueous solutions of hydrophilic polymers, wetting agents and other additives.

For certain applications, it is furthermore advantageous to increase the mechanical strength of the printing layers by subjecting them to a heat treatment (what is referred as “baking”) and/or overall exposure (e.g. to UV light). For this purpose, prior to the treatment, the plate is treated with a solution that protects the non-image areas such that the heat treatment does not cause these areas to accept ink. A solution suitable for this purpose is e.g. described in U.S. Pat. No. 4,355,096. Baking usually takes place at temperatures in the range of 150 to 250° C. However, printing plates prepared from printing plate precursors according to the present invention show excellent properties even without having been subjected to a heat treatment or overall exposure. When both baking and overall exposure are carried out, the two treatment steps can be performed simultaneously or one after the other.

Lithographic printing plate precursors according to the present invention are characterized by improved photosensitivity in combination with good storage stability; the developed printing plates exhibit excellent abrasion resistance which allows a large number of copies.

The invention will be explained in more detail in the following examples.

### EXAMPLES

### Preparation Example 1

(Preparation of a Compound of Formula (III) Wherein n=1 and k=2)

In a three-necked flask, equipped with a stirrer, a condenser and a thermometer, 35.0 g phosphorous pentoxide were suspended in 150 ml dry THF. A solution of 36.25 g allyl alcohol in 50 ml dry THF was slowly added drop-wise in order to prevent the temperature from exceeding 15° C. After all of the solution had been added, the reaction mixture was brought to room temperature and stirred for 1 hour. Then it was slowly heated to the boiling temperature (about 65° C.) and stirred for 2 hours. Subsequently, 4.5 g water were added and the mixture was kept at 65° C. for another 2 hours. Then the THF was distilled off under vacuum at 40° C. The obtained compound was used without any further purification.

### Preparation Example 2

(Preparation of a Compound of Formula (III) Wherein n=2 and k=1)

In a three-necked flask, equipped with a stirrer, a condenser and a thermometer, 140 g phosphorous pentoxide were suspended in 600 ml dry THF. A solution of 232 g allyl alcohol in 200 ml dry THF was slowly added drop-wise in order to prevent the temperature from exceeding 15° C. After all of the solution had been added, the reaction mixture was brought to room temperature and stirred for 1 hour. Then it was slowly heated to the boiling temperature (about 65° C.) and stirred for 2 hours. Subsequently, 20 g water were added and the mixture was kept at 65° C. for another 2 hours. Then the THF was distilled off under vacuum at 40° C. The obtained compound was used without any further purification.

### Examples 1 to 6 and Comparative Examples 1 to 6

An electrochemically roughened (T=50° C.; electrolyte: 1.1 wt.-% aqueous HCl; current density: 50 A/dm²) and anodized aluminum foil was subjected to a treatment with an aqueous solution of polyvinyl phosphonic acid (PVPA). The pretreated substrate (average peak-to-valley height: 0.6 μm) was coated with the solution shown in Table 1.

TABLE 1

| | | |
|---|---|---|
| 2.06 | g | of a 30% propyleneglycol monomethylether solution |
| | | of a terpolymer prepared by polymerizing 476 parts |
| | | by weight styrene, 476 parts by weight |
| | | methylmethacrylate and 106 parts by weight |
| | | methacrylic acid |
| 0.30 | g | compound A |
| 0.30 | g | mercapto-3-triazole |
| 0.41 | g | ditrimethyloipropane tetraacrylate |
| 0.061 | g | compound B₁ |
| or | | or |
| 0.097 | g | compound B₂ |
| 1.25 | g | of a dispersion in propyleneglycol monomethylether |
| | | comprising 7.25 wt. - % copper phthalocyanine and |
| | | 7.25 wt. - % polyvinylacetal binder comprising |
| | | 39.9 mole - % vinyl alcohol groups, 1.2 mole - % |
| | | vinyl acetate groups, 15.4 mole - % acetal groups |
| | | derived from acetaldehyde, 36.1 mole - % acetal |
| | | groups derived from butyric aldehyde and |
| | | 7.4 mole - % acetal groups derived from |
| | | 4-formylbenzoic acid |
| 0.115 | g | compound C |
| 0.26 | g | compound D |
| 3.58 | g | compound E |
| 39.5 | g | propyleneglycol monomethylether |
| 4.0 | g | acetone |

After filtration, the solution was applied to the pretreated substrate and the coating was dried for 4 minutes at 90° C. The weight of the photopolymer layer was about 2 g/m².

The obtained samples were coated with an overcoat by applying an aqueous solution of poly(vinylalcohol) (Airvol 203 available from Airproducts; degree of hydrolysis: 88%). After drying for 4 minutes at 90° C., a printing plate precursor with a dry overcoat layer weight of about 3 g/m² was obtained.

The printing plate precursor was exposed to the light of a tungsten lamp having a metal interference filter for 405 nm for 120 seconds through a gray scale having a tonal range of 0.15 to 1.95, wherein the density increments amount to 0.15 (UGRA gray scale). After exposure, the plate was immediately heated in an oven for 2 minutes at 90° C.

The exposed plate precursor was treated for 30 seconds with a developer solution comprising the following components:
3.4 parts by weight Rewopol NLS 28® (available from the company REWO)
1.1 parts by weight diethanol amine
1.0 parts by weight Texapon 842® (available from the company-Henkel)
0.6 parts by weight Nekal BX Pastes (available from the company BASF)
0.2 parts by weight 4-toluene sulfonic acid and
93.7 parts by weight water

Then the developer solution was again rubbed over the surface for another 30 seconds using a tampon and then the entire plate was rinsed with water. After this treatment, the exposed portions remained on the plate. For the assessment of its photosensitivity, the plate was blackened in a wet state with printing ink.

For the assessment of storage stability, the unexposed printing plate precursors were stored for 60 minutes in a 90° C. oven, then exposed and developed as described above (storage stability test).

For evaluating the preheat latitude, the exposed plates were heated in an infrared heating device NE459/125P from BasysPrint at a plate rate of 60 cm/min wherein the temperature was adjusted such that a temperature of 140° C. (measured with a temperature strip on the back of the plate) was reached on the plate surface (preheating latitude test).

For the preparation of a lithographic printing plate, a printing layer is applied to the aluminum foil, as explained above, exposed, heated, developed, and after rinsing with water, the developed plate is rubbed with an aqueous solution of 0.5% phosphoric acid and 6% gum arabic. The thus prepared plate is loaded in a sheet-fed offset printing machine and used for printing with an abrasive printing ink (Offset S7184 available from Sun Chemical, containing 10% potassium carbonate).

The results are summarized in Table 2.

TABLE 2

| | | | | | | | | Gray | | | |
|---|---|---|---|---|---|---|---|---|---|---|---|
| | | | | | | | Gray | scale | | | |
| | | | | | | | scale | 405 nm¹⁾ | | Drop | |
| | | | | | Com- | Gray | 405 nm¹⁾ | 140 min/ | | test⁴⁾ | Durability |
| | Compound | Compound | Compound | Compound | pound | scale | 60 min/ | 60 cm | Drop | 60 min/ | during |
| Example | A | B | C | D | E | 405 nm¹⁾ | 90° C.²⁾ | min³⁾ | test⁴⁾ | 90° C.²⁾ | printing |
| 1 | P-OH | Coumarin | Irgacure | Iodonium | ¹¹⁾ | 6/8 | 5/7 | 7/9 | 5/5 | 5/5 | no wear up to |
| | monomer⁵⁾ | M⁶⁾ | 784⁷⁾ | salt⁸⁾ | | | | | | | 50000 copies |
| 2 | P-OH | Coumarin | Irgacure | Iodonium | ¹¹⁾ | 5/7 | 4/6 | 6/8 | 5/5 | 5/5 | no wear up to |
| | monomer⁵⁾ | J⁶⁾ | 784⁷⁾ | salt⁸⁾ | | | | | | | 50000 copies |
| 3 | Synthesis | Coumarin | Irgacure | Iodonium | ¹¹⁾ | 5/8 | 5/7 | 6/9 | 5/5 | 5/5 | no wear up to |
| | example 1 | M⁶⁾ | 784⁷⁾ | salt⁸⁾ | | | | | | | 50000 copies |
| 4 | Synthesis | Coumarin | Irgacure | Iodonium | ¹¹⁾ | 6/8 | 5/8 | 7/10 | 5/5 | 5/5 | no wear up to |
| | example 2 | M⁶⁾ | 784⁷⁾ | salt⁸⁾ | | | | | | | 50000 copies |
| 5 | P-OH | Coumarin | none | o-Cl-Habi¹⁰⁾ | ¹¹⁾ | 5/7 | 5/7 | 5/8 | 5/5 | 5/5 | no wear up to |
| | monomer⁵⁾ | M⁶⁾ | | | | | | | | | 50000 copies |
| 6 | P-OH | Coumarin | Irgacure | o-Cl-Habi¹⁰⁾ | ¹¹⁾ | 6/8 | 5/7 | 7/9 | 5/5 | 5/10 | no wear up to |
| | monomer⁵⁾ | M⁶⁾ | 784⁷⁾ | | | | | | | | 50000 copies |
| Comp. 1 | P-OH | none | Irgacure | Iodonium | ¹¹⁾ | 1/4 | 1/3.5 | 2/4 | 5/5 | 5/5 | wear up to |
| | monomer⁵⁾ | | 784⁷⁾ | salt⁸⁾ | | | | | | | 10000 copies |
| Comp. 2 | P-OH | Coumarin | Irgacure | none | ¹¹⁾ | 2/4 | 3/5.5 | 5/7 | 5/5 | 5/5 | wear up to |
| | monomer⁵⁾ | M⁶⁾ | 784⁷⁾ | | | | | | | | 10000 copies |
| Comp. 3 | none | Coumarin | Irgacure | Iodonium | ¹¹⁾ | 6/8 | not de- | not de- | >25/ | not de- | not determined |
| | | M⁶⁾ | 784⁷⁾ | salt⁸⁾ | | | velopable | velopable | 15 | velopable | |
| Comp. 4 | none | none | Irgacure | Iodonium | ¹¹⁾ | 1/4 | not de- | not de- | >25/ | not de- | not determined |
| | | | 784⁷⁾ | salt⁸⁾ | | | velopable | velopable | 15 | velopable | |
| Comp. 5 | none | Coumarin | Irgacure | none | ¹¹⁾ | 3/6 | 1/5.5 | 4/7 | >25/ | >25/>25 | wear up to |
| | | M⁶⁾ | 784⁷⁾ | | | | | | 15 | | 10000 copies |
| Comp. 6 | P-OH | Coumarin | Irgacure | Iodonium | ¹²⁾ | 1/3 | 1/4 | 1/4 | 5/5 | 10/10 | wear up to |
| | monomer⁵⁾ | 1⁶⁾ | 784⁷⁾ | salt⁸⁾ | | | | | | | 10000 copies |

¹⁾The first value indicates the solid steps of the blackened gray scale and the second value indicates the first step that does not accept printing ink.
²⁾Storage stability test: Result obtained after 60 minute storage of the unexposed plate precursors at 90° C.
³⁾Preheating latitude test: Result obtained after the exposed plate passed through a 140° C. oven
⁴⁾The first value, indicates the time required for the developer to clean the plate without rubbing; the second value indicates the time required for cleaning the plate after blackening.
⁵⁾P-OH monomer: one mole phosphoric acid esterified with 1.5 moles hydroxyethyl methacrylate
⁶⁾Coumarin M: 3-carbethoxy-7-(diethylamino)-coumarin
⁷⁾Irgacure 784: (Bis(cyclopentadienyl)-bis-[2,6-difluoro-3-(pyrr-1-yl)-phenyl]titanium from CIBA Specialities, Switzerland
⁸⁾lodonium salt: diphenyliodoniumchloride
⁹⁾Coumarin J: 3,3′-carbonyl-bis-(7-dimethylaminocoumarin)
¹⁰⁾2,2-Bis(2-chlorophenyl)-4,5,4′,5′-tetraphenyl-2H′-[1,2′]biimidazolyl
¹¹⁾80% Methyl ethyl ketone solution of a urethane acrylate prepared by reacting Desmodur N 100 ® (available from Bayer) with hydroxyethyl acrylate and pentaerythritol triacrylate; amount of double bonds: 0.5 double bonds per 100 g when all isocyanate groups have reacted with the acrylates containing hydroxy groups
¹²⁾Dipentaerythritol hexaacrylate

### Comparative Example 7

An aluminum foil that had been roughened electrochemically with nitric acid and anodized was subjected to a treatment with an aqueous solution of polyvinylphosphonic acid. The substrate treated in this manner was coated with the same coating solution as used in Example 1.

The behavior of the plates on the printing machine according to the examples of the present invention was not attained; after a 30-minute break, the plate did not roll up within 50 copies in the non-image areas while in the examples of the present invention, the plate did roll up after at most 10 copies.

Table 2 clearly shows that only the photopolymer composition of the present invention comprising at least components (i), (ii), and (iii), together with the aluminum substrate roughened with HCl, lead to good storage stability, a certain preheating latitude, good photosensitivity as well as developability and durability during printing.

Comparative Examples 1 to 6 show that the absence of one or more of
(i) at least one free-radical polymerizable monomer with P—OH group (compound A)
(ii) a sensitizer of formula (I) (compound B)
(iii) a coinitiator selected from onium compounds, hexaarylbiimidazole compounds and trihalogenomethyl compounds (compound D) and
(iv) a biuret oligomer (compound E)
   markedly reduces sensitivity.

Examples 1 to 4 and Comparative Examples 3 to 5 clearly show that a free-radical polymerizable monomer with at least one ethylenically unsaturated free-radical polymerizable group and at least one P—OH group (compound A) is necessary to realize sufficient storage stability and developability.

Example 1 and Comparative Example 7 show that electrochemical roughening with hydrochloric acid is superior to roughening with nitric acid since the treatment with hydrochloric acid leads to a lower tendency to toning.

1-14. (canceled)

15. A radiation-sensitive element comprising
(a) an aluminum substrate pretreated by electrochemical roughening and thereafter optionally anodizing or applying a hydrophilizing layer or both, wherein the electrochemical roughening is carried out with a hydrochloric acid electrolyte or an electrolyte consisting essentially of hydrochloric acid, and
(b) a radiation-sensitive coating comprising
(1) at least one free-radical polymerizable monomer with at least one ethylenically unsaturated polymerizable group and at least one P—OH group,
(2) at least one sensitizer represented by formula (1), 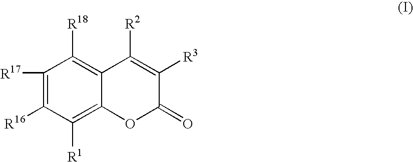
wherein
(i) R¹, R¹⁶, R¹⁷ and R¹⁸ are independently a hydrogen atom, a halogen atom, C₁-C₂₀ alkyl, —OH, —O—R⁴ or —NR⁵R⁶, wherein R⁴ is C₁-C₂₀ alkyl, C₅-C₁₀ aryl or C₆-C₃₀ aralkyl and R⁵ and R⁶ are independently a hydrogen atom or C₁-C₂₀ alkyl; or
(ii) R¹ and R¹⁶, R¹⁶ and R¹⁷, or R¹⁷ and R¹⁸ together form a 5- or 6-membered heterocyclic ring with a N or O heteroatom in one or both positions adjacent to the phenyl ring, or
(iii) or R¹, R¹⁶ and R¹⁷ form two adjacent 5- or 6-membered heterocyclic rings with a N or O heteroatom in a position adjacent to the phenyl ring;
wherein each formed 5- or 6-membered heterocyclic ring can independently be substituted with one or more C₁-C₆ alkyl,
with the proviso that at least one of R¹, R¹⁶, R¹⁷ and R¹⁸ is not a hydrogen atom or C₁-C₂₀ alkyl,
R² is a hydrogen atom, C₁-C₂₀ alkyl, C₅-C₁₀ aryl or C₆-C₃₀ aralkyl and
R³ is a hydrogen atom, —COOH, —COOR⁷, —COR⁸, —CONR⁹R¹⁰, —CN, C₅-C₁₀ aryl, C₆-C₃₀ aralkyl, a 5- or 6-membered heterocyclic ring, —CH═CH—R¹² or 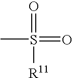
wherein R⁷ is C₁-C₂₀ alkyl, R⁸ is C₁-C₂₀ alkyl or a 5- or 6-membered heterocyclic ring, R⁹ and R¹⁰ are independently a hydrogen atom or C₁-C₂₀ alkyl, R¹¹ is C₁-C₁₂ alkyl or alkenyl, a heterocyclic non-aromatic ring or C₅-C₂₀ aryl optionally including an O, S or N heteroatom, and R¹² is C₅-C₁₀ aryl or a 5- or 6-membered heterocyclic, optionally aromatic, ring;
or R² and R³, together with the carbon atoms to which they are bonded, form a 5- or 6-membered, optionally aromatic, ring;
(3) at least one onium compound, hexaarylbiimidazole compound, or trihalogenomethyl compound as a coinitiator;
(4) at least one biuret oligomer represented by formula (V) 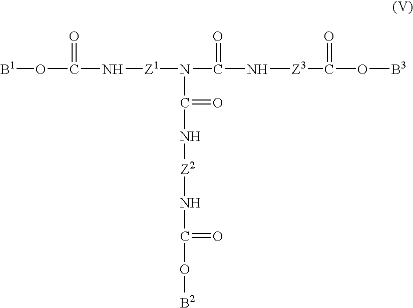
wherein Z¹, Z² and Z³ are independently C₂-C₁₈ alkanediyl or C₆-C₂₀ arylene,
B¹, B² and B³ are independently
—(CHR¹³—CHR¹³—O)ₚ—CH₂—CH═CH₂ or a fragment represented by formula (Va) 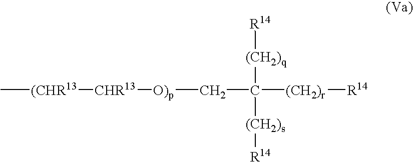
wherein R¹³ is independently a hydrogen atom or —CH₃ and p is 0 or an integer from 1-10, each R¹⁴ is independently a hydrogen atom, 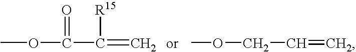
R¹⁵ is a hydrogen atom or C₁-C₁₂ alkyl and
q, r and s independently of each other are 0 or 1,
with the proviso that for B¹, B² and B³ at least one R¹⁴ is not a hydrogen atom if B¹, B² and B³ are all a fragment represented by formula (Va), and
(5) optionally at least one metallocene.

16. The radiation-sensitive element according to claim 15, wherein the radiation-sensitive coating additionally comprises at least one further component comprising free-radical polymerizable monomers, oligomers, or prepolymers that are different from monomers (b)(1) of the radiation-sensitive coating, alkali-soluble binders, thermopolymerization inhibitors, dyes, plasticizers, chain transfer agents, leuco dyes, inorganic fillers or surfactants.

17. The radiation-sensitive element according to claim 15, wherein the sensitizer is represented by formulas Ia-Ih, Ij-Ik and Im-Iq, or mixtures thereof:

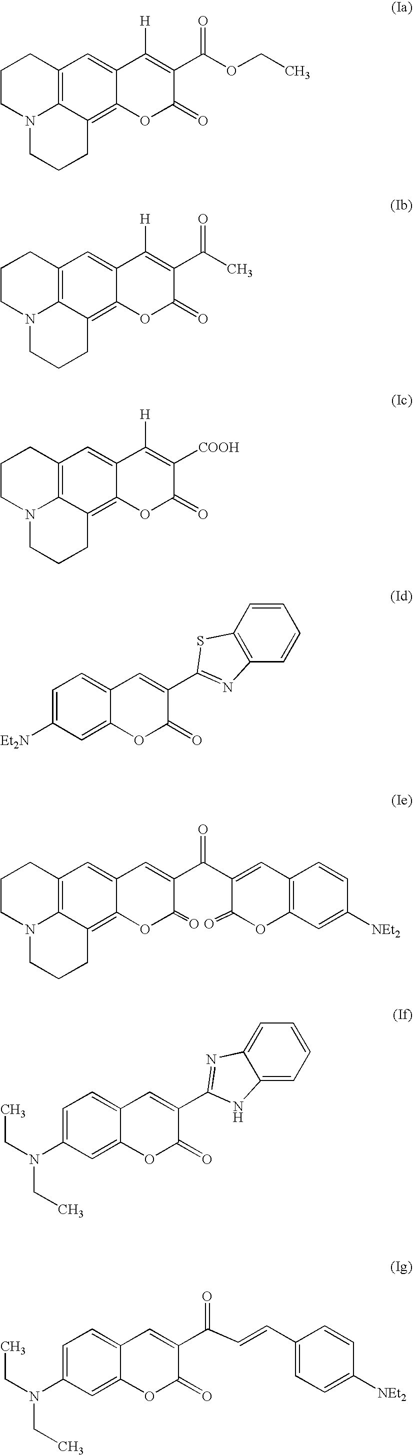

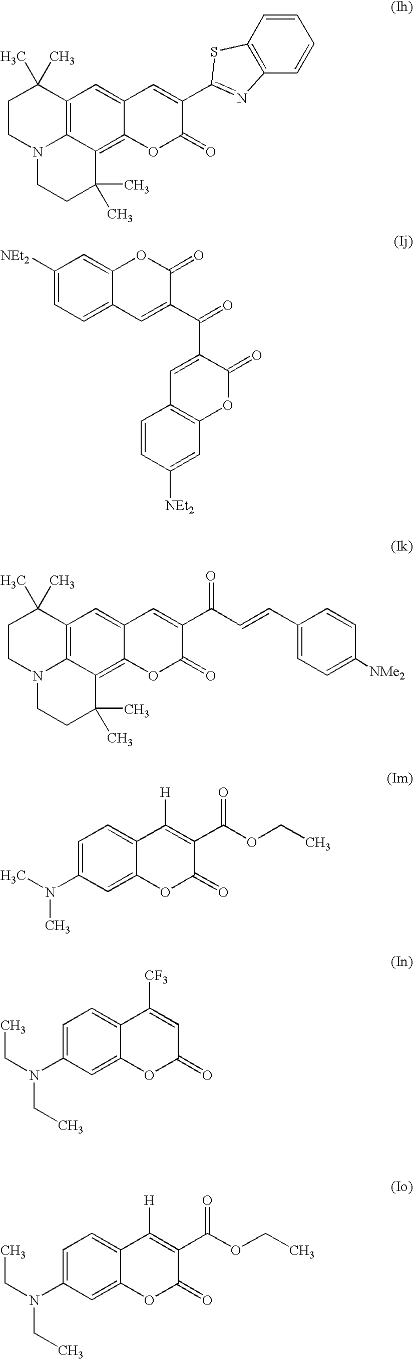

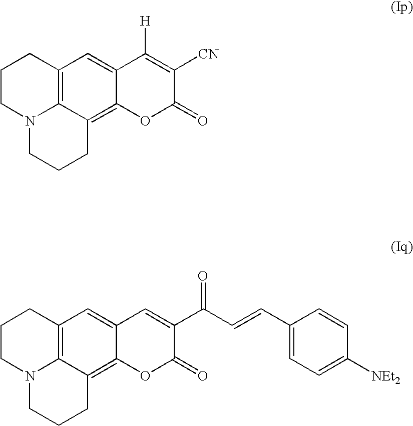

18. The radiation-sensitive element according to claim 15, wherein the coinitiator is an iodonium compound or a hexaarylbiimidazole compound.

19. The radiation-sensitive element according to claim 15, wherein the radiation-sensitive coating comprises a metallocene with a metal of the fourth subgroup as a central atom.

20. The radiation-sensitive element according to claim 15, wherein the free-radical polymerizable monomer with at least one ethylenically unsaturated group and at least one P—OH group is represented by formulas (II) and (III): 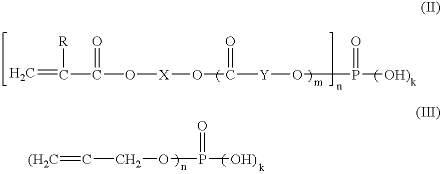
wherein n is 1 or 2,
m is 0 or 1,
k is 1 or 2,
n+k=3,
R is a hydrogen atom or C₁-C₁₂ alkyl,
X is C₂-C₁₂ alkanediyl and
Y is C₂-C₁₂ alkanediyl.

21. The radiation-sensitive element according to claim 15, wherein in the biuret of formula (V) each of Z¹, Z², and Z³ are the same.

22. The radiation-sensitive element according to claim 15, wherein an oxygen-impermeable overcoat is provided on the radiation-sensitive coating.

23. A process for the production of an imaged element comprising the steps of:
(a) providing a radiation-sensitive element comprising
(1) an aluminum substrate pretreated by electrochemical roughening and thereafter optionally anodizing or applying a hydrophilizing layer or both, wherein the electrochemical roughening is carried out with a hydrochloric acid electrolyte or an electrolyte consisting essentially of hydrochloric acid, and
(2) a radiation-sensitive coating comprising
(i) at least one free-radical polymerizable monomer with at least one ethylenically unsaturated polymerizable group and at least one P—OH group,
(ii) at least one sensitizer represented by formula (1), 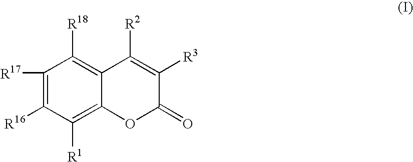
wherein
(a) R¹, R¹⁶, R¹⁷ and R¹⁸ are independently a hydrogen atom, a halogen atom, C₁-C₂₀ alkyl, —OH, —O—R⁴ or —NR⁵R⁶, wherein R⁴ is C₁-C₂₀ alkyl, C₅-C₁₀ aryl or C₆-C₃₀ aralkyl and R⁵ and R⁶ are independently a hydrogen atom or C₁-C₂₀ alkyl; or
(b) R¹ and R¹⁶, R¹⁶ and R¹⁷, or R¹⁷ and R¹⁸ together form a 5- or 6-membered heterocyclic ring with a N or O heteroatom in one or both positions adjacent to the phenyl ring, or
(c) or R¹, R¹⁶ and R¹⁷ form two adjacent 5- or 6-membered heterocyclic rings with a N or O heteroatom in a position adjacent to the phenyl ring;
wherein each formed 5- or 6-membered heterocyclic ring can independently be substituted with one or more C₁-C₆ alkyl,
with the proviso that at least one of R¹, R¹⁶, R¹⁷ and R¹⁸ is not a hydrogen atom or C₁-C₂₀ alkyl,
R² is a hydrogen atom, C₁-C₂₀ alkyl, C₅-C₁₀ aryl or C₆-C₃₀ aralkyl and
R³ is a hydrogen atom —COOH, —COOR⁷, —COR⁸, —CONR⁹R¹⁰, —CN, C₅-C₁₀ aryl, C₆-C₃₀ aralkyl, a 5- or 6-membered heterocyclic ring, —CH═CH—R¹² or 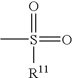
wherein R⁷ is C₁-C₂₀ alkyl, R⁸ is C₁-C₂₀ alkyl or a 5- or 6-membered heterocyclic ring, R⁹ and R¹⁰ are independently a hydrogen atom or C₁-C₂₀ alkyl, R¹¹ is C₁-C₁₂ alkyl or alkenyl, a heterocyclic non-aromatic ring or C₅-C₂₀ aryl optionally including an O, S or N heteroatom, and R¹² is C₅-C₁₀ aryl or a 5- or 6-membered heterocyclic, optionally aromatic, ring;
or R² and R³, together with the carbon atoms to which they are bonded, form a 5- or 6-membered, optionally aromatic, ring;
(3) at least one onium compound, hexaarylbiimidazole compound, or trihalogenomethyl compound as a co-initiator;
(4) at least one biuret oligomer represented by formula (V) 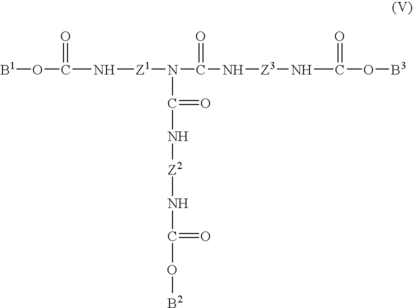
wherein Z¹, Z² and Z³ are independently C₂-C₁₈ alkanediyl or C₆-C₂₀ arylene,
B¹, B² and B³ are independently —(CHR¹³—CHR¹³—O)ₚ—CH₂—CH═CH₂ or a fragment represented by formula (Va) 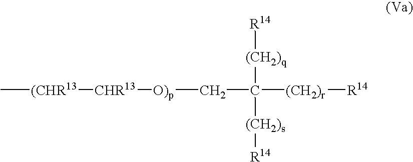
wherein R¹³ is independently a hydrogen atom or —CH₃ and p is 0 or an integer from 1-10, each R¹⁴ is independently a hydrogen atom, 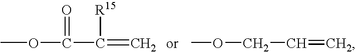
R¹⁵ is a hydrogen atom or C₁-C₁₂ alkyl and
q, r and s independently of each other are 0 or 1,
with the proviso that for B¹, B² and B³ at least one R¹⁴ is not a hydrogen atom if B¹, B² and B³ are all a fragment represented by formula (Va), and
(5) optionally at least one metallocene;
(b) image-wise exposure of the element with radiation of a wavelength adjusted to the sensitizer present in the radiation-sensitive layer of the element;
(c) optionally heating;
(d) removing the unexposed areas with an aqueous alkaline developer; and
(e) optionally heating the imaged element obtained in step (d) or subjecting it to overall exposure or both.

24. A radiation-sensitive composition comprising
(a) at least one free-radical polymerizable monomer with at least one ethylenically unsaturated polymerizable group and at least one P—OH group,
(b) at least one sensitizer represented by formula (I) 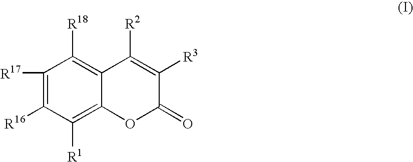
wherein
(1) R¹, R¹⁶, R¹⁷ and R¹⁸ are independently a hydrogen atom, a halogen atom, C₁-C₂₀ alkyl, —OH, —O—R⁴ or —NR⁵R⁶, wherein R⁴ is C₁-C₂₀ alkyl, C₅-C₁₀ aryl or C₆-C₃₀ aralkyl and R⁵ and R⁶ are independently a hydrogen atom or C₁-C₂₀ alkyl, or
(2) R¹ and R¹⁶, R¹⁶ and R¹⁷, or R¹⁷ and R¹⁸ together form a 5- or 6-membered heterocyclic ring with a N or O heteroatom, in one or both positions adjacent to the phenyl ring, or
(3) R¹, R¹⁶ and R¹⁷ form two adjacent 5- or 6-membered heterocyclic rings with a N or O heteroatom, in a position adjacent to the phenyl ring,
wherein each formed 5- or 6-membered heterocyclic ring can independently be substituted with one or more C₁-C₆ alkyl,
with the proviso that at least one of R¹, R¹⁶, R¹⁷ and R¹⁸ is not a hydrogen atom or C₁-C₂₀ alkyl;
R² is a hydrogen atom, C₁-C₂₀ alkyl, C₅-C₁₀ aryl or C₆-C₃₀ aralkyl and
R³ is hydrogen atom, or —COOH, —COOR⁷, —COR⁸, —CONR⁹R¹⁰, —CN, C₅-C₁₀ aralkyl, a 5- or 6-membered heterocyclic ring, —CH═CH—R¹² or 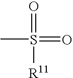
wherein R⁷ is C₁-C₂₀ alkyl, R⁸ is C₁-C₂₀ alkyl or a 5- or 6-membered heterocyclic ring, R⁹ and R¹⁰ are independently a hydrogen atom or C₁-C₂₀ alkyl, R¹¹ is C₁-C₁₂ alkyl, or C₁-C₁₂ alkenyl, a heterocyclic non-aromatic ring
or C₅-C₂₀ aryl optionally including an O, S or N heteroatom, and R¹² is C₅-C₁₀ aryl or a 5- or 6-membered heterocyclic, optionally aromatic, ring;
or R² and R³, together with the carbon atoms to which they are bonded, form a 5- or 6-membered, optionally aromatic, ring;
(c) at least one onium compound, hexaarylbiimidazole compound, or trihalogenomethyl compound as a coinitiator;
(d) at least one biuret oligomer represented by formula (V) 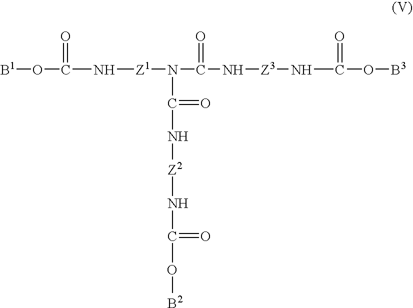
wherein Z¹, Z² and Z³ are independently C₂-C₁₈ alkanediyl or C₆-C₂₀ arylene,
B¹, B² and B³ are independently
—(CHR¹³—CHR¹³—O)ₚ—CH₂—CH═CH₂ or a fragment represented by formula (Va) 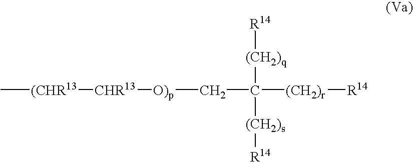
wherein R¹³ is independently a hydrogen atom or
—CH₃ and p is 0 or an integer from 1-10, each R¹⁴ is independently a hydrogen atom, 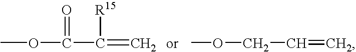
R¹⁵ is a hydrogen atom or C₁-C₁₂ alkyl and
q, r and s independently of each other are 0 or 1,
with the proviso that for B¹, B² and B³ at least one R¹⁴ is not a hydrogen atom if B¹, B² and B³ are all a fragment represented by formula (Va), and
(e) a solvent or solvent mixture; and
(f) optionally at least one metallocene.

25. The radiation-sensitive composition according to claim 24, additionally comprising at least one further component comprising a free-radical polymerizable monomers, oligomers, or prepolymers that are different from monomer (a) of the radiation-sensitive composition, alkali-soluble binders, thermopolymerization inhibitors, dyes, plasticizers, chain transfer agents, leuco dyes, inorganic fillers or surfactants.

26. A process for the production of a radiation-sensitive element as defined in claim 15 comprising:
(a) providing an aluminum substrate pretreated by electrochemical roughening and thereafter optionally anodizing or applying a hydrophilizing layer or both, wherein the electrochemical roughening is carried out with a hydrochloric acid electrolyte or an electrolyte consisting essentially of hydrochloric acid;
(b) applying a radiation-sensitive composition comprising
(1) at least one free-radical polymerizable monomer with at least one ethylenically unsaturated polymerizable group and at least one P—OH group,
(2) at least one sensitizer represented by formula (I) 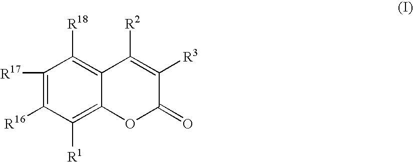
wherein
(i) R¹, R¹⁶, R¹⁷ and R¹⁸ are independently a hydrogen atom, a halogen atom, C₁-C₂₀ alkyl, —OH, —O—R⁴ or —NR⁵R⁶, wherein R⁴ is C₁-C₂₀ alkyl C₅-C₁₀ aryl or C₆-C₃₀ aralkyl and R⁵ and R⁶ are independently a hydrogen atom or C₁-C₂₀ alkyl, or
(ii) R¹ and R¹⁶, R¹⁶ and R¹⁷, or R¹⁷ and R¹⁸ together form a 5- or 6-membered heterocyclic ring with a N or O heteroatom, in one or both positions adjacent to the phenyl ring, or
(iii) R¹, R¹⁶ and R¹⁷ form two adjacent 5- or 6-membered heterocyclic rings with a N or O heteroatom, in a position adjacent to the phenyl ring,
wherein each formed 5- or 6-membered heterocyclic ring can independently be substituted with one or more C₁-C₆ alkyl groups,
with the proviso that at least one of R¹, R¹⁶, R¹⁷ and R¹⁸ is not a hydrogen atom or C₁-C₂₀ alkyl;
R² is a hydrogen atom, C₁-C₂₀ alkyl, C₅-C₁₀ aryl or C₆-C₃₀ aralkyl and
R³ is hydrogen atom, —COOH, —COOR⁷, —COR⁸, —CONR⁹R¹⁰, —CN, C₅-C₁₀ aralkyl, a 5- or 6-membered heterocyclic ring, —CH═CH—R¹² or 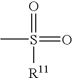
wherein R⁷ is C₁-C₂₀ alkyl, R⁸ is C₁-C₂₀ alkyl or a 5- or 6-membered heterocyclic ring, R⁹ and R¹⁰ are independently a hydrogen atom or C₁-C₂₀ alkyl, R¹¹ is C₁-C₁₂ alkyl, or C₁-C₁₂ alkenyl, a heterocyclic non-aromatic ring or C₅-C₂₀ aryl optionally including an O, S or N heteroatom, and R¹² is C₅-C₁₀ aryl or a 5- or 6-membered heterocyclic, optionally aromatic, ring;
or R² and R³, together with the carbon atoms to which they are bonded, form a 5- or 6-membered, optionally aromatic, ring;
(3) at least one onium compound, hexaarylbiimidazole compound, or trihalogenomethyl compound as a coinitiator;
(4) at least one biuret oligomer represented by formula (V) 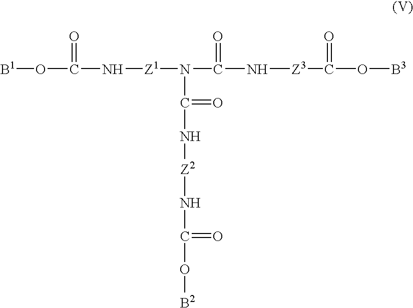
wherein Z¹, Z² and Z³ are independently C₂-C₁₈ alkanediyl or C₆-C₂₀ arylene,
B¹, B² and B³ are independently
—(CHR¹³—CHR¹³—O)ₚ—CH₂—CH═CH₂ or a fragment represented by formula (Va) 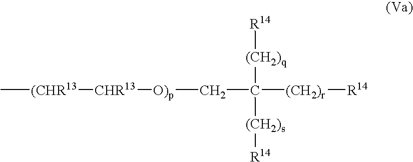
wherein R¹³ is independently a hydrogen atom or
—CH₃ and p is 0 or an integer from 1-10, each R¹⁴ is independently a hydrogen atom, 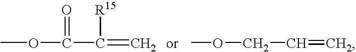
R¹⁵ is a hydrogen atom or C₁-C₁₂ alkyl and
q, r and s independently of each other are 0 or 1,
with the proviso that for each B¹, B² and B³ at least one R¹⁴ is not a hydrogen atom if B¹, B² and B³ are all a fragment represented by formula (Va), and
(5) a solvent or solvent mixture; and
(6) optionally at least one metallocene.
(c) drying; and
(d) optionally applying an oxygen-impermeable overcoat and drying.

27. The printing form produced by the process according to claim 23.
